(19) United States
(12) Patent Application Publication
(10) Pub. No.: US 2008/0272964 A1
(43) Pub. Date: Nov. 6, 2008

(54) Antenna Radiator Assembly and Radio Communications Assembly

(75) Inventors: Wei Su, Beijing (CN); Guang Ping Zhou, Beijing (CN)

Correspondence Address: MOTOROLA INC, 600 NORTH US HIGHWAY 45, W4 - 39Q, LIBERTYVILLE, IL, 60048-5343, US

(73) Assignee: Motorola, Inc., Libertyville, IL (US)

(21) Appl. No.: 10/596,526

(22) PCT Filed: Dec. 7, 2004
(86) PCT No.: PCT/US04/40928

§ 371 Date: Aug. 22, 2006

(30) Foreign Application Priority Data
Dec. 18, 2003 (CH) 200310123225.8

(51) Int. Cl. H01Q 1/38; H01Q 1/24

(52) U.S. Cl. 343/702; 343/700 MS

(57) ABSTRACT

An antenna radiator assembly (2) and radio communications assembly (1) comprising a circuit board (5) formed from dielectric layers dielectric layers (21, 22) supporting electrical conductors. The electrical conductors include a feed point conductive trace (23) and conductive sheets (7, 24) comprising a ground plane. An antenna radiator element (8) is spaced from the circuit board (5) and when viewed in plan view there is an overlapping area (25) where most of a surface area of the antenna radiator element (8) overlaps a surface area of the circuit board (26) thereby forming a sandwiched dielectric region (25). A feed point connector (11) couples the antenna radiator element (8) to the feed point conductive trace (23) and a ground connector (10) couples the antenna radiator element (8) to the ground plane. The circuit board dielectric layers (21, 22) in the sandwiched dielectric region (25) are disposed between the antenna radiator element (8) and the ground plane.

### FIELD OF THE INVENTION

This invention relates to an antenna radiator assembly and radio communications assembly including an antenna radiator assembly. The invention is particularly useful for, but not necessarily limited to, multi-band wireless communication devices with internal antennas.

### BACKGROUND ART OF THE INVENTION

Wireless communication devices often require multi-band antennas for transmitting and receiving radio communication signals. For example, network operators providing service on a GSM system in a 900 MHz frequency band typically used in Asia also use a DCS system in a 1800 MHz frequency band typically used in Europe. Accordingly, GSM wireless communication devices, such as cellular radio telephones, should have dual band antennas to be able to effectively communicate at least at both of these frequencies. Also, in certain countries service providers operate on 850 MHz or 1900 MHz frequency bands.

Internal antenna radiator structures, using a radiator element in the form of a micro-strip internal patch antenna, are considered advantageous in several ways because of their compact lightweight structure, which is relatively easy to fabricate and produce with precise printed circuit techniques capable of integration on printed circuit boards. Most known internal patch antennas tend to have a narrow bandwidth, unless a thick dielectric substrate or mount is employed. However, the resulting thick substrate or mount affects antenna characteristics and limits their use in many applications, particularly in handheld mobile communication devices with severe space and weight constraints.

Conventional patch antennas have natural resonant frequencies or modes for RF and microwave applications. However, there are shortcomings when using natural modes for antenna designs. Natural modes are dependent on the shape and size of the patch. Once the dimensions of the antenna are fixed, the resonant frequencies are also fixed. If the size of the antenna is such that the first mode matches the GSM (900 MHZ) frequency, then the second mode will resonate at its third harmonic, 2700 MHZ, which is not recommended for the DCS (1800 MHZ) frequency. Additionally, to generate natural mode resonant frequencies, the size of the antenna must be relatively large.

Current consumer requirements are for compact wireless communication devices that typically have an internal antenna instead of an antenna stub that is visible to the user. Small cellular telephones now require a miniaturized antenna comprising an antenna radiator structure coupled to a ground plane, the ground planes being typically formed on or in a circuit board of the telephone. Further, the antenna radiator structure is installed inside the phone where congested conductive and “lossy” components are placed nearby. The antenna must be able to cover multiple frequency bands to, for instance, accommodate the 850 MHz, 900 MHz, 1800 Mhz and 1900 Mhz bands whilst being compact.

In addition to the above, internal antenna radiator elements are typically spaced from circuit board and when viewed in plan view at least most of a surface area of the antenna radiator element overlaps a surface of the circuit board forming a sandwiched region. This sandwich region is filled with one or more dielectric mediums including air and the mount (typically made of plastics) for the radiator element. However, in addition to the “lossy” components the antenna's characteristics and performance may be affected by ground planes and signal lines on or in the circuit board that also overlap the antenna radiator element. One solution to reduce the affects of ground planes and signal lines on the antenna's characteristics and performance is to space the antenna radiator element further away from the circuit board. However, this would inevitably result in a thicker device that may not be acceptable for portable communications devices that are tending to become smaller due to consumer requirements. Another solution is to increase the thickness of the mount, unfortunately this would also affect antenna performance and characteristics. Accordingly, a need exists for relatively compact internal antenna radiator assembly or structure.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided an antenna radiator assembly comprising:
a circuit board formed from a plurality of dielectric layers dielectric layers with electrical conductors thereon, the electrical conductors including a feed point conductive trace and at least one conductive sheet comprising a ground plane;
at least one antenna radiator element spaced from said circuit board and when viewed in plan view there is an overlapping area where at least most of a surface area of the antenna radiator element overlaps a surface area of the circuit board thereby forming a sandwiched dielectric region therebetween;
a feed point connector coupling the antenna radiator element to the feed point conductive trace; and
a ground connector coupling the antenna radiator element to the ground plane,
wherein there is at least one of the circuit board dielectric layers in the sandwiched dielectric region disposed between the antenna radiator element and the ground plane.

Suitably, there is at least one of the circuit board dielectric layers in the sandwiched dielectric region disposed between the antenna radiator element and the feed point conductive trace.

Suitably, at least one of the circuit board dielectric layers in the sandwiched dielectric region have an area extending across the complete overlapping area.

Preferably, the feed point conductive trace and the at least one conductive sheet are the only the electrical conductors supported by the circuit board and extending into the overlapping area.

Preferably, all of the dielectric layers forming the circuit board are disposed between the antenna radiator element and the ground plane.

Suitably, all of the dielectric layers forming the circuit board are disposed between the antenna radiator element and the feed point conductive trace.

Preferably, the feed point conductive trace is mounted on a first one of the dielectric layers when outside the overlapping area and when the feed point conductive trace is extending into the overlapping area it is mounted on a different one of the dielectric layers.

Preferably, the conductive sheet and feed point conductive trace are on an outer dielectric layer surface of the circuit board that is facing away from the antenna radiator element. Suitably, the at least one conductive sheet is a first conductive sheet coupled to another conductive sheet on a different dielectric layer. Suitably, the first conductive sheet is coupled to the another conductive sheet by a plurality of vias. The vias are suitably spaced centre to centre by no more than 1/100^{th} of a wavelength when the element is resonating at a pre-defined operating frequency. Preferably, the vias are spaced along an axis transverse to a longitudinal axis of the circuit board.

A radio communications assembly comprising:
a circuit board formed from a plurality of dielectric layers dielectric layers with electrical conductors thereon, the electrical conductors including a feed point conductive trace and at least one conductive sheet comprising a ground plane;
a transceiver coupled to at least one antenna radiator element via a radio frequency amplifier, the at least one antenna radiator element spaced from said circuit board and when viewed in plan view there is an overlapping area where at least most of a surface area of the antenna radiator element overlaps a surface area of the circuit board thereby forming a sandwiched dielectric region therebetween;
a feed point connector coupling the antenna radiator element to the feed point conductive trace; and
a ground connector coupling the antenna radiator element to the ground plane,
wherein there is at least one of the circuit board dielectric layers in the sandwiched dielectric region disposed between the antenna radiator element and the ground plane.

Suitably, there is at least one of the circuit board dielectric layers in the sandwiched dielectric region disposed between the antenna radiator element and the feed point conductive trace.

Suitably, at least one of the circuit board dielectric layers in the sandwiched dielectric region have an area extending across the complete overlapping area.

Preferably, the feed point conductive trace and the at least one conductive sheet are the only the electrical conductors supported by the circuit board and extending into the overlapping area.

Preferably, all of the dielectric layers forming the circuit board are disposed between the antenna radiator element and the ground plane.

Suitably, all of the dielectric layers forming the circuit board are disposed between the antenna radiator element and the feed point conductive trace.

Preferably, the feed point conductive trace is mounted on a first one of the dielectric layers when outside the overlapping area and when the feed point conductive trace is extending into the overlapping area it is mounted on a different one of the dielectric layers.

Preferably, the conductive sheet and feed point conductive trace are on an outer dielectric layer surface of the circuit board that is facing away from the antenna radiator element.

Suitably, the at least one conductive sheet is a first conductive sheet coupled to another conductive sheet on a different dielectric layer. Suitably, the first conductive sheet is coupled to the another conductive sheet by a plurality of vias. The vias are suitably spaced centre to centre by no more than 1/100^{th} of a wavelength when the element is resonating at a pre-defined operating frequency. Preferably, the vias are spaced along an axis transverse to a longitudinal axis of the circuit board.

### BRIEF DESCRIPTION OF THE DRAWINGS

In order that the invention may be readily understood and put into practical effect, reference will now be made to preferred embodiments as illustrated with reference to the accompanying drawings in which:

FIG. 1 is a not to scale perspective view of part of a radio communications assembly including an antenna radiator assembly in accordance with the invention;

FIG. 2 is a side view of the antenna radiator assembly shown in FIG. 1.

FIG. 3 is a top plan view of the antenna radiator assembly of FIG. 2.

FIG. 4 is an underside plan view of the antenna radiator assembly of FIG. 2; and

FIG. 5 is a top plan view of the antenna radiator assembly of FIG. 2 with an upper dielectric insulator and associated conductors removed.

### DETAILED DESCRIPTION OF THE PREFERRED EMBODIMENTS OF THE INVENTION

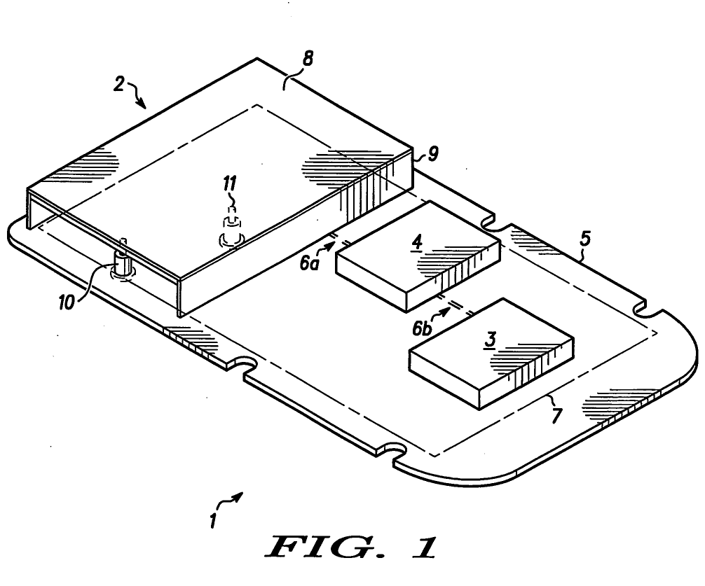

In the drawings, like numerals on different Figs are used to indicate like elements throughout. With reference to FIG. 1, there is illustrated a radio communications assembly 1 comprising an antenna radiator assembly 2 coupled to a transceiver 3 via a radio frequency amplifier 4. The antenna radiator assembly 2 comprises a circuit board 5 with electrically interconnecting runners 6 and a plurality of sandwiched electrically conductive sheets, such as a first conductive sheet 7 (shown in phantom due to it being sandwiched in circuit board 5) providing part of a ground plane The antenna radiator assembly 2 also has an antenna radiator element 8 spaced from the circuit board 5, the antenna radiator element 8 being mounted to a dielectric plastics mount 9 and electrically connected to a ground connector 10 and a feed point connector 11. There are also other typical components/modules (not shown for clarity) and other conductive sheets combined or coupled by conductive vias (not shown for clarity in this Fig) forming the ground plane that are mounted on or in the circuit board 5.

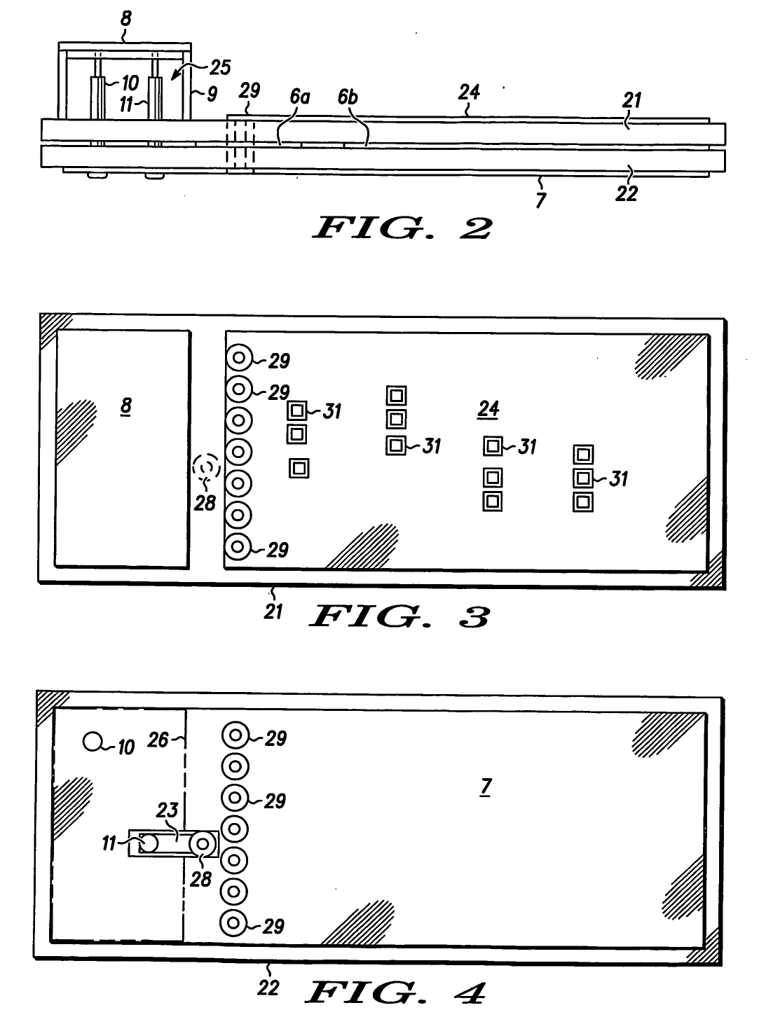

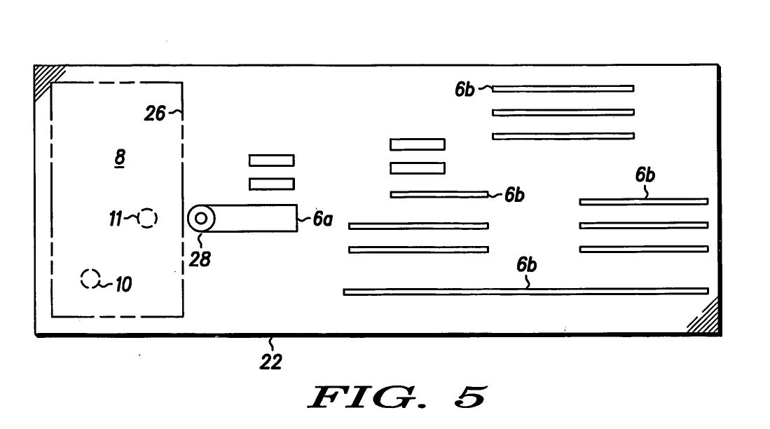

In the remainder of this specification, FIGS. 2 to 5 will be referred to in general and when necessary reference will be made temporarily to a specific Fig. when required. In FIGS. 2 to 5 there is illustrated the antenna radiator assembly 2. The circuit board 5 is formed from a plurality of dielectric layers 21, 22 with electrical conductors disposed thereon. The circuit board 5 and illustrated features are not to size and are for illustration purposes only. Also, the number of dielectric layers 21, 22 are typically greater than 2 and there can be 5 or even more such dielectric layers. The electrical conductors include runners 6a, 6b, a feed point conductive trace 23, the first conductive sheet 7 and another conductive sheet 24 providing the ground plane.

When viewed in the plan view of FIG. 4, there is an overlapping area where at least most of a surface area of the antenna radiator element 8 overlaps a surface area, indicated by the dotted line boundary 26 of the circuit board 5 thereby forming a sandwiched dielectric region 25 therebetween. In this embodiment, the sandwiched dielectric region 25 includes the plastics dielectric mount 9 and the dielectric layers 21, 22 inside the boundary 26. The feed point connector 11 provides for coupling the antenna radiator element to the feed point conductive trace 23 and the a ground connector 10 provides for coupling the antenna radiator element 8 to the first conductive sheet 7 of the ground plane. As will be apparent to a person skilled in the art, connectors 10,11 are typically spring loaded pins that are often referred to as “pogo pins”.

As shown specifically in FIG. 2, the circuit board dielectric layers 21, 22 in the sandwiched dielectric region 25 are disposed between the antenna radiator element 8 and the first conductive sheet 7 of the ground plane. Also, the circuit board dielectric layers 21, 22 in the sandwiched dielectric region 25 are disposed between the antenna radiator element 8 and the feed point conductive trace 23.

To facilitate the coupling the antenna radiator element 8 to the first conductive sheet 7 and feed point conductive trace 23 there are apertures (not shown) in both the circuit board 5 and plastics dielectric mount for allowing the connectors 10,11 passage therethrough. As illustrated, all of the circuit board dielectric layers 21,22 in the sandwiched dielectric region 25 have an area extending across the complete overlapping area identified by the dotted line boundary 26, the dielectric layers 21,22 being disposed between the antenna radiator element 8 and both the ground plane 7 and feed point conductive trace 23. Furthermore, the feed point conductive trace 23 and the first conductive sheet 7 are the only the electrical conductors supported by the dielectric layers 21,22 of the circuit board 5 that extend into the overlapping area identified by the dotted line boundary 26.

In this embodiment, the feed point conductive trace 23 is mounted on a first one of the dielectric layers (layer 21) when outside the overlapping area 26 and is therefore essentially runner 6a on dielectric layer 6a, and when the feed point conductive trace 23 is extending into the overlapping region 25 it is mounted on a different one of the dielectric layers (layer 22). A conductive via 28 is used to couple runner 6a to feed point conductive trace 23. However, in other embodiments the feed point conductive trace 23 may directly couple with a component such as the radio frequency amplifier 4 that could be mounted to dielectric layer 22. In other words, there may be no need for the via 28 if the feed point conductive trace, when outside the overlapping region 25, is mounted to the same side as when it is inside the overlapping region 25. Ground plane conductive vias 29 are also used to couple the first conductive sheet 7 to the another conductive sheet 24, the ground plane conductive vias 29 are typically spaced, centre to centre, by no more than 1/100^{th} of a wavelength when the element 8 is resonating at a pre-defined operating frequency. This alleviates the possibility of standing waves and “hot spots” as will be apparent to a person skilled in the art. Moreover, the vias 29 are spaced 1/100^{th} of a wavelength apart along an axis Tax transverse to a longitudinal axis Lax of the circuit board.

As illustrated, the antenna radiator element 8 and circuit board 5 are substantially parallel. Also the first conductive sheet 7 and feed point conductive trace 23 are on an outer dielectric layer 22 surface of the circuit board 5 that is facing away from the antenna radiator element 8. Further, there are mounting pads 31 that are respectively coupled to the runners 6b, the pads 31 are on dielectric layer 21 and are spaced for electric isolation from the another conductive sheet 24.

Advantageously, the present invention provides for compact multi band internal antenna radiator assembly capable of operating at specified bands. Because the first conductive sheet 7 and feed point conductive trace 23 are on an outer dielectric layer 22 surface of the circuit board 5 that is facing away from the antenna radiator element 8 the dielectric characteristics of the sandwiched dielectric region 25 are enhanced without requiring a thicker mount 9, more spacing; or additional dielectrics materials being inserted between circuit board 5 and the antenna radiator element 8. However, it should be noted that even if the first conductive sheet 7 and feed point conductive trace 23 are on not on the outer dielectric layer 22 that is facing away from the antenna radiator element 8, advantages would still be obtained by even a single circuit board dielectric layer being disposed in the sandwiched dielectric region 25 between the antenna radiator element 8 and both the ground plane and feed point conductive trace 23.

It should be noted that in this specification, internal antenna has the meaning of an antenna enclosed inside the communications device or an antenna with a radiator element forming part of a housing wall of the communications device. The detailed description provides preferred exemplary embodiments only, and is not intended to limit the scope, applicability, or configuration of the invention. Rather, the detailed description of the preferred exemplary embodiments provide those skilled in the art with an enabling description only. It should be understood that various changes may be made in the function and arrangement of elements without departing from the spirit and scope of the invention as set forth in the appended claims.

We claim:

1. An antenna radiator assembly comprising:
a circuit board formed from a plurality of dielectric layers dielectric layers with electrical conductors thereon, the electrical conductors including a feed point conductive trace and at least one conductive sheet comprising a ground plane;
at least one antenna radiator element spaced from said circuit board and when viewed in plan view there is an overlapping area where at least most of a surface area of the antenna radiator element overlaps a surface area of the circuit board thereby forming a sandwiched dielectric region therebetween;
a feed point connector coupling the antenna radiator element to the feed point conductive trace; and
a ground connector coupling the antenna radiator element to the ground plane,
wherein there is at least one of the circuit board dielectric layers in the sandwiched dielectric region disposed between the antenna radiator element and the ground plane.

2. An antenna radiator assembly as claimed in claim 1, wherein, there is at least one of the circuit board dielectric layers in the sandwiched dielectric region disposed between the antenna radiator element and the feed point conductive trace.

3. An antenna radiator assembly as claimed in claim 2, wherein the at least one of the circuit board dielectric layers in the sandwiched dielectric region have an area extending across the complete overlapping area.

4. An antenna radiator assembly as claimed in claim 3, wherein the feed point conductive trace and the at least one conductive sheet are the only the electrical conductors supported by the circuit board and extending into the overlapping area.

5. An antenna radiator assembly as claimed in claim 1, wherein all of the dielectric layers forming the circuit board are disposed between the antenna radiator element and the ground plane.

6. An antenna radiator assembly as claimed in claim 1, wherein all of the dielectric layers forming the circuit board are disposed between the antenna radiator element and the feed point conductive trace.

7. An antenna radiator assembly as claimed in claim 1, wherein the feed point conductive trace is mounted on a first one of the dielectric layers when outside the overlapping area and when the feed point conductive trace is extending into the overlapping area it is mounted on a different one of the dielectric layers.

8. An antenna radiator assembly as claimed in claim 1, wherein 1 the conductive sheet and feed point conductive trace are on an outer dielectric layer surface of the circuit board that is facing away from the antenna radiator element.

9. An antenna radiator assembly as claimed in claim 1, wherein the at least one conductive sheet is a first conductive sheet coupled to another conductive sheet on a different dielectric layer.

10. An antenna radiator assembly as claimed in claim 9, wherein the first conductive sheet is coupled to the another conductive sheet by a plurality of vias.

11. An antenna radiator assembly as claimed in claim 10, wherein the vias are suitably spaced centre to centre by no more than 1/100^{th} of a wavelength when the element is resonating at a pre-defined operating frequency.

12. An antenna radiator assembly as claimed in claim 10, Preferably, the vias are spaced along an axis transverse to a longitudinal axis of the circuit board.

13. A radio communications assembly comprising:
a circuit board formed from a plurality of dielectric layers dielectric layers with electrical conductors thereon, the electrical conductors including a feed point conductive trace and at least one conductive sheet comprising a ground plane;
a transceiver coupled to at least one antenna radiator element via a radio frequency amplifier, the at least one antenna radiator element spaced from said circuit board and when viewed in plan view there is an overlapping area where at least most of a surface area of the antenna radiator element overlaps a surface area of the circuit board thereby forming a sandwiched dielectric region therebetween;
a feed point connector coupling the antenna radiator element to the feed point conductive trace; and
a ground connector coupling the antenna radiator element to the ground plane,
wherein there is at least one of the circuit board dielectric layers in the sandwiched dielectric region disposed between the antenna radiator element and the ground plane.

14. A radio communications assembly as claimed in claim 13, wherein there is at least one of the circuit board dielectric layers in the sandwiched dielectric region disposed between the antenna radiator element and the feed point conductive trace.

15. A radio communications assembly as claimed in claim 14, wherein at least one of the circuit board dielectric layers in the sandwiched dielectric region have an area extending across the complete overlapping area.

16. A radio communications assembly as claimed in claim 15, wherein the feed point conductive trace and the at least one conductive sheet are the only the electrical conductors supported by the circuit board and extending into the overlapping area.

17. A radio communications assembly as claimed in claim 10, wherein all of the dielectric layers forming the circuit board are disposed between the antenna radiator element and the ground plane.

18. A radio communications assembly as claimed in claim 13, wherein all of the dielectric layers forming the circuit board are disposed between the antenna radiator element and the feed point conductive trace.

19. A radio communications assembly as claimed in claim 13, wherein the feed point conductive trace is mounted on a first one of the dielectric layers when outside the overlapping area and when the feed point conductive trace is extending into the overlapping area it is mounted on a different one of the dielectric layers.

20. A radio communications assembly as claimed in claim 13, wherein the conductive sheet and feed point conductive trace are on an outer dielectric layer surface of the circuit board that is facing away from the antenna radiator element.

21. A radio communications assembly as claimed in claim 13, wherein the at least one conductive sheet is a first conductive sheet coupled to another conductive sheet on a different dielectric layer.

22. A radio communications assembly as claimed in claim 21, wherein the first conductive sheet is coupled to the another conductive sheet by a plurality of vias.

23. An antenna radiator assembly as claimed in claim 22, wherein the vias are spaced centre to centre by no more than 1/100^{th} of a wavelength when the element is resonating at a pre-defined operating frequency.

24. An antenna radiator assembly as claimed in claim 22, wherein the vias are spaced along an axis transverse to a longitudinal axis of the circuit board.
